(19) United States
(12) Patent Application Publication
(10) Pub. No.: US 2010/0031916 A1
(43) Pub. Date: Feb. 11, 2010

(54) Hypocycloid Engine

(76) Inventor: Randall Wiseman, Bay St. Louis, MS (US)

Correspondence Address: BLANK ROME LLP, WATERGATE, 600 NEW HAMPSHIRE AVENUE, N.W., WASHINGTON, DC, 20037, US

(21) Appl. No.: 11/886,841

(22) PCT Filed: Mar. 21, 2006
(86) PCT No.: PCT/US2006/010209

§ 371 Date: Oct. 20, 2009

Related U.S. Application Data
(60) Provisional application No. 60/663,579, filed on Mar. 21, 2005.

(51) Int. Cl. F02B 75/32

(52) U.S. Cl. 123/197.1

(57) ABSTRACT

The present invention relates to a hypocycloid engine assembly which may be used in internal combustion engines. The engine assembly is able to transfer power from a purely linear reciprocating piston to a purely rotational output shaft, increasing the efficiency and stability of the gear assembly and engine. The engine assembly may also be used in applications converting purely rotational motion to purely linear motion, for example, in air compressors or hydraulic systems.

### FIELD OF INVENTION

The present invention relates to a hypocycloid engine assembly which may be used in internal combustion engines. The engine assembly is able to transfer power from a purely linear reciprocating piston to a purely rotational output shaft, increasing the efficiency and stability of the gear assembly and engine. The engine assembly may also be used in applications converting purely rotational motion to purely linear motion, for example, in air compressors or hydraulic systems.

### BACKGROUND OF THE INVENTION

Conventional reciprocating piston engines and gear mechanisms are well known in the prior art. In the conventional engine, the connecting rod joins the piston to the gear assembly and assumes a slightly canted position during the piston cycle. This is caused by the linear motion of the piston on one end of the connecting rod and the circular motion of the gear assembly on the other end of the connecting rod. The canting or offset of the connecting rod reduces the driving force transferred from the piston to the gear assembly, because part of the force in the piston is dissipated in a lateral direction of the connecting rod. The canting also produces piston side loading which increases the amount of friction between the piston and the walls of a cylinder holding the piston. Furthermore, the rotation of the connecting rod at the gear assembly makes it more difficult to eliminate vibrational effects and balance the engine.

Hypocycloid gearing mechanisms in internal combustion engines have been developed to eliminate the canting in the connecting rod of conventional engines. However, many hypocycloid gearing mechanisms in the prior art are extremely complicated, having multiple gears and counterweights.

U.S. Pat. Nos. 4,237,741 to Huf et al and 5,067,456 to Beachley et al are examples of such complex hypocycloid devices. In the background of U.S. Pat. No. 4,237,741 it is disclosed that certain hypocycloids operate in a manner where an externally-toothed gear wheel rolls on or meshes with the gear rim of an inwardly-toothed gear wheel, where the diameter of the inwardly-toothed gear wheel is in the ratio of 2:1 to the externally-toothed gear wheel. Furthermore, it is also disclosed that there are several disadvantages to this configuration relating to gear overloading, possible configurations and unsatisfactory lubrication.

However, commonly assigned U.S. Pat. No. 6,510,831 to Wiseman discloses a hypocycloid gear assembly where the diameter of the inwardly-toothed gear is in the ratio of 2:1 to the externally-toothed gear. The hypocycloid gear assembly comprises a pinion shaft connected to the connecting rod by a pinion journal. A pinion carrier is placed over the pinion shaft so that both the pinion shaft and carrier move in unison. The pinion carrier travels in a circle around a center of axis which coincides with the center of axis of the output shaft. The output shaft thereby rotates on its own axis with no other consequential motion. This hypocycloid gear assembly disclosed in U.S. Pat. No. 6,510,831 provides a simple and efficient means of converting linear motion to rotational motion. The gear mechanism performs this conversion using only two moving parts, the pinion shaft and the pinion carrier. The reduction of the gear assembly to two moving parts makes it easier to assembly and reduces the amount of friction generated between the moving parts.

It would be desirable to have other possible hypocycloid engine configurations that are simple and efficient means of converting linear motion to rotational motion where a minimum of moving parts are used to obtain the advantages of a hypocycloid gear assembly.

### SUMMARY OF THE INVENTION

In view of the foregoing, it should be apparent that there exists a need to have a simple hypocycloid gear arrangement for converting linear motion to rotary motion in an efficient manner.

In embodiments of the invention, the one-piece, unitary hypocycloid engine pinion of the present invention converts a purely linear motion in the connecting rod to a purely rotational motion in an output shaft by operating together with the one piece, unitary drive shaft. The hypocycloid engine pinion according to the invention comprises a pinion body having a longitudinal axis and defining an opening adapted to receive a drive shaft journal and a cylinder rod journal substantially adjacent to the pinion body and having a longitudinal axis substantially parallel to and laterally offset from the longitudinal axis of the pinion body. The cylinder rod journal is also adapted to receive the drive shaft journal.

In embodiments of the invention the hypocycloid engine pinion is combined together with a drive shaft with at least one drive shaft journal to form a hypocycloid engine pinion assembly. The drive shaft journal has a longitudinal axis and at least one power output shaft substantially adjacent to the drive shaft journal and having a longitudinal axis substantially parallel to and laterally offset from the longitudinal axis of the drive shaft journal. The pinion body travels in a circle around a center of axis which coincides with the center of axis of the power output shaft. The output shaft thereby rotates on its own axis with no other consequential motion.

The hypocycloid engine pinion assembly of the present invention improves on the prior art by providing a simple and efficient means of converting linear motion to rotational motion. The gear mechanism performs this conversion using only two moving parts {other than any piston(s) and associated connecting rod(s)}, the pinion and the drive shaft. The reduction of the number of pieces in the gear assembly to two moving parts makes it easier to manufacture and assemble and reduces the amount of friction generated between the moving parts.

Accordingly, the invention provides a hypocycloid mechanism which allows the piston and connecting rod to have a purely linear motion which is converted by the pinion and drive shaft mechanisms to a purely rotational motion in an output shaft.

The invention provides a means to eliminate the canting in the connecting rod so as to eliminate piston side loading and increase the efficiency of the engine.

The invention provides a means to direct all the energy of the piston into the connecting rod and eliminate any energy loss in a lateral direction to the connecting rod.

With these and other objects, advantages and features of the invention that may become hereinafter apparent, the nature of the invention may be more clearly understood by reference to the following description of the invention, the appended claims and to the several drawings attached herein.

### DESCRIPTION OF DRAWINGS

FIG. 1 shows a side view and an end view of the pinion of the present invention;

FIG. 2 shows a side view and an end view of the drive shaft of the present invention;

FIG. 3 is a side view of the piston/rod assembly of the present invention;

FIG. 4 shows two side sectional views of the engine housing/ring gear of the present invention;

FIG. 5 shows an exploded view of the drive components shown in FIGS. 1-4;

FIG. 6 shows a side cut-away of the assembled components rotating through one complete engine cycle in 90 degree increments including arrows depicting their rotational relationships;

FIG. 7 shows three different side cut-away and/or sectional views of the assembled components including arrows depicting their rotational relationships;

FIG. 8 shows a side sectional view of the assembled pinion gear assembly of the present invention connected to two opposed pistons in an engine housing;

FIG. 9 shows a side sectional view of the assembled pinion gear assembly of the present invention connected to two opposed pistons in an engine housing including arrows depicting their rotational relationships; and

FIG. 10 shows another side sectional view of the assembled pinion gear assembly of the present invention connected to two opposed pistons in an engine housing including arrows depicting their rotational relationships;

### DESCRIPTION OF INVENTION

As described above, In the background of U.S. Pat. No. 4,237,741 it is disclosed that certain hypocycloids operate in a manner where an externally-toothed gear wheel rolls on or meshes with the gear rim of an inwardly-toothed gear wheel, where the diameter of the inwardly-toothed gear wheel is in the ratio of 2:1 to the externally-toothed gear wheel. Furthermore, it is also disclosed that there are several disadvantages to this configuration relating to gear overloading, possible configurations and unsatisfactory lubrication.

In contrast to these statements in U.S. Pat. No. 4,237,741, Applicant has unexpectedly discovered that gear overloading and undue gear stress does not occur in the hypocycloid engine assembly of the present invention. Specifically, in an internal combustion engine application, both at top dead center “TDC” and bottom dead center “BDC” the pinion gear and ring gear have zero torque as all the force vectors are aligned in a direction parallel to the central longitudinal axis of the cylinder bore of the engine housing. It is also an advantage of the invention that at both 90 degrees and 270 degrees of rotation in the cycle where gear loading of the pinion gear and the ring gear are at their maximum, the pressure has diminished dramatically in the internal combustion cycle causing the gear loading present due to the combustion engine forces to be well within the limits that the gears will handle.

Similarly, the same is true for the advantages of the present invention in respect of an application where the power output shaft is driven and the piston(s) apply force, for example a compressor. Specifically, at the positions of both 90 degrees and 270 degrees of rotation in the cycle where the gear loading is at the maximum, the piston is seeing either 50% of the maximum air pressure or is seeing little or no pressure on the suction side of the compressor cycle. In the only case where this represents any substantial amount of stress on the gears, i.e., the compression cycle, the gear loading is diminishing as the piston approaches the maximum pressure at TDC where there is 100% bearing loading and zero percent gear loading. Accordingly, there is no gear overloading and undue gear stress in the hypocycloid engine assembly of the present invention.

It should be noted that the embodiment shown in all the Figures represents an opposed two cylinder/piston arrangement in accordance with the invention. Many other configurations are possible using the basic elements of the hypocycloid engine assembly of the present invention. In line embodiments with any even or odd number of pistons are possible as well as 90 degree “V” engines or “X” motors.

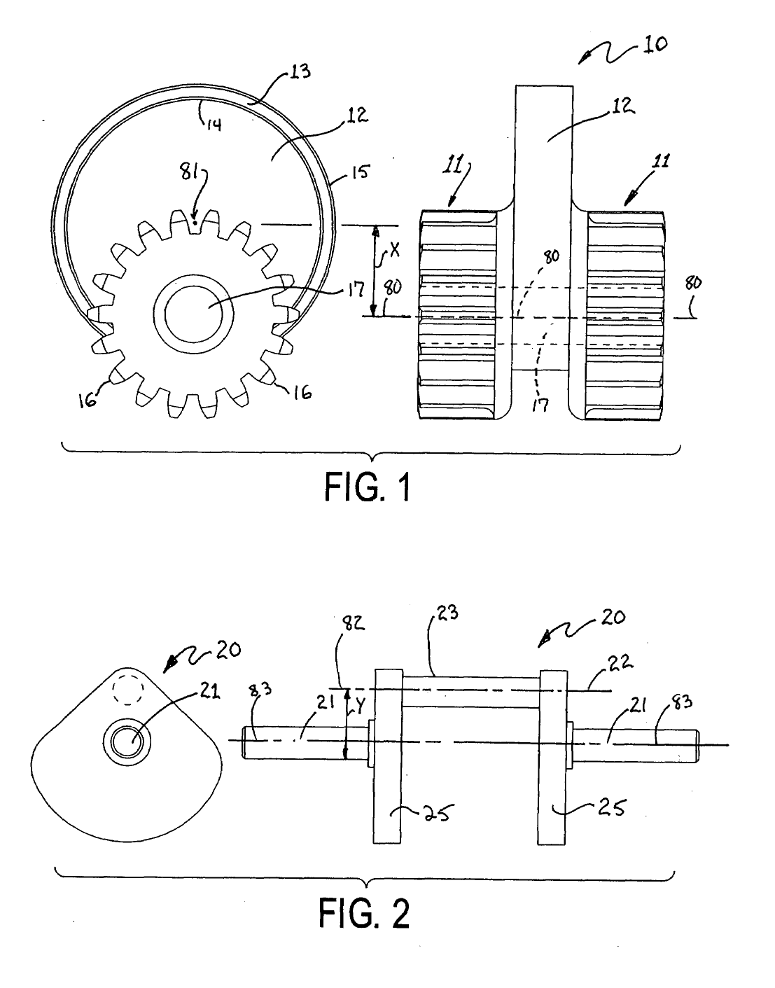

Furthermore, although in FIG. 1 a pinion 10 with two pinion bodies 11 is shown, the objects of the invention may be accomplished by a device with a pinion comprising one pinion body 11 and one cylinder rod journal 12. In a similar fashion, the drive shaft 20 shown in the Figures is an embodiment of the invention having two power output shafts 21 and only one is necessary in order to accomplish the objects of the invention. Only one ring gear 30 is necessary as well, even though an embodiment is depicted herein with two, and the engine housing 35 shown in FIG. 4 may be modified accordingly.

FIG. 1 shows a side view and an end view of the pinion 10 of the present invention. In the end view the rotational axes of the pinion body 11 and the cylinder rod journal 12 are normal or perpendicular to the page and a bearing 13 is shown by two circular lines on the outside surface of the cylinder rod journal 14. The outermost circular line 15 indicates the point of contact of the piston/rod assembly 40 with the bearing 13. The side view is a 90 degree rotation from the end view and shows the teeth 16 on the pinion body 11 as well as phantom lines showing the opening adapted to receive the drive shaft journal 17 that extends through the pinion body 11 and the cylinder rod journal 12.

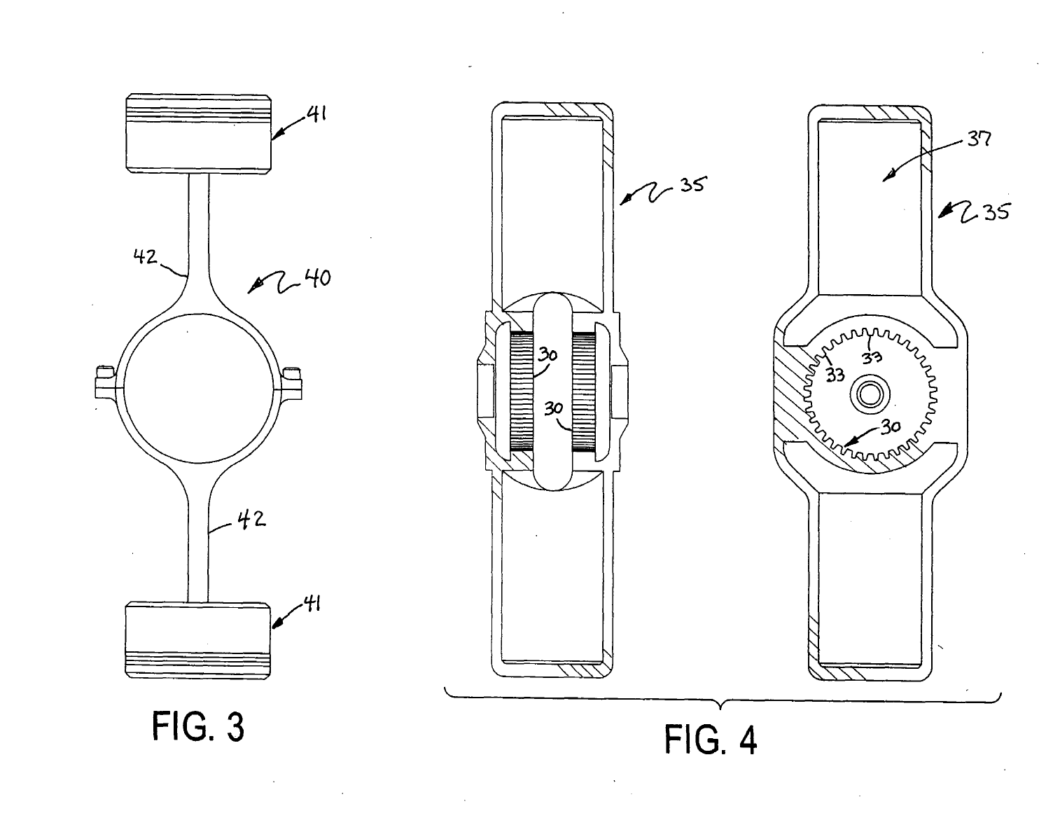

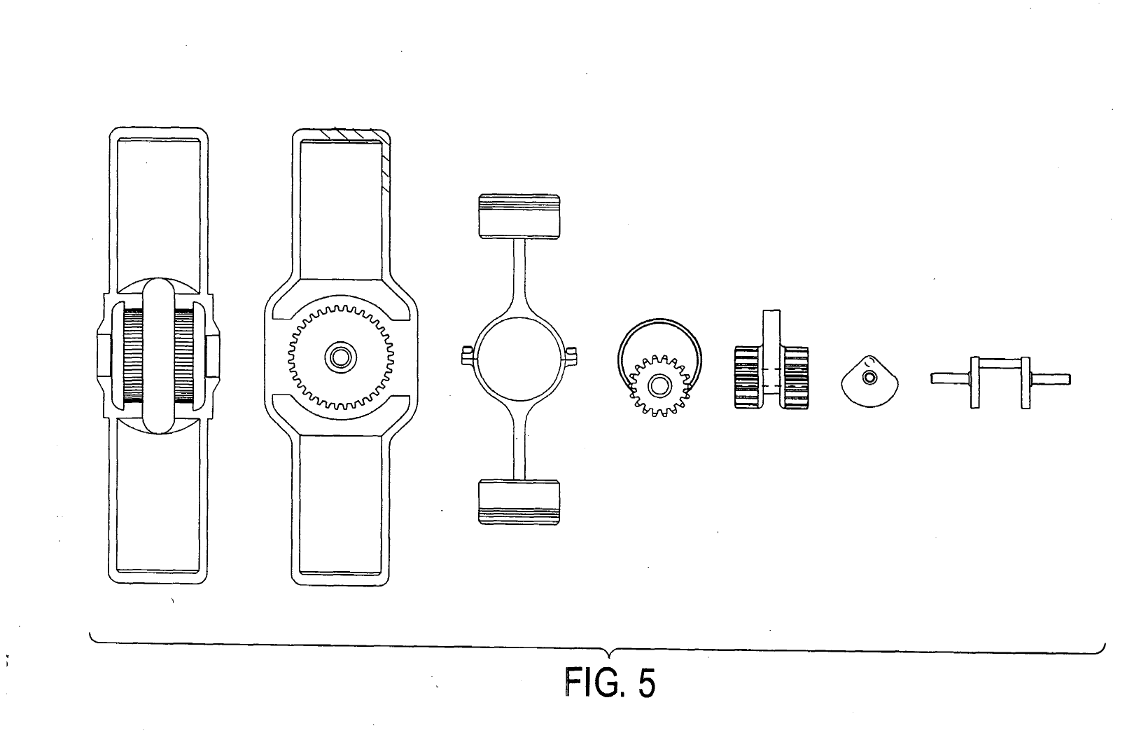

FIG. 3 shows a piston rod assembly 40 comprising two pistons 41 and two connecting rods 42. In the case of FIG. 4 the two drawings on the page represent a 90 degree rotation from each other. Ring gear teeth 33 are shown which, in embodiments of the invention, engage pinion body teeth 16. FIG. 5 is an exploded view and compilation of the elements of the invention shown in FIGS. 1-4.

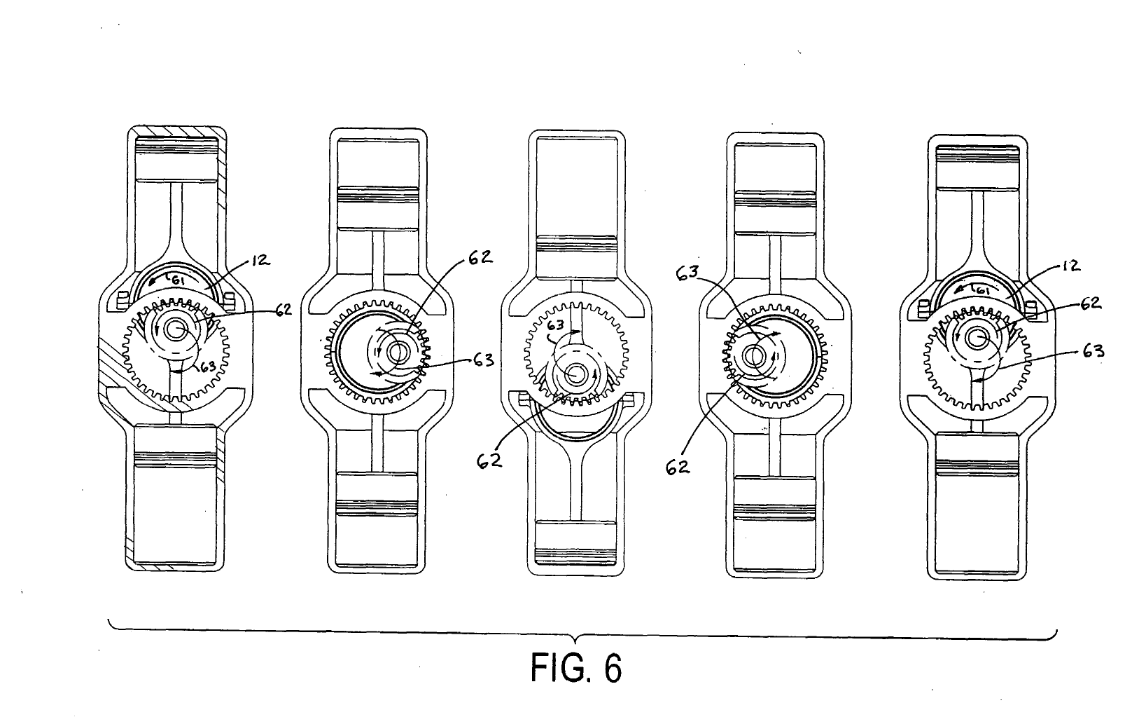

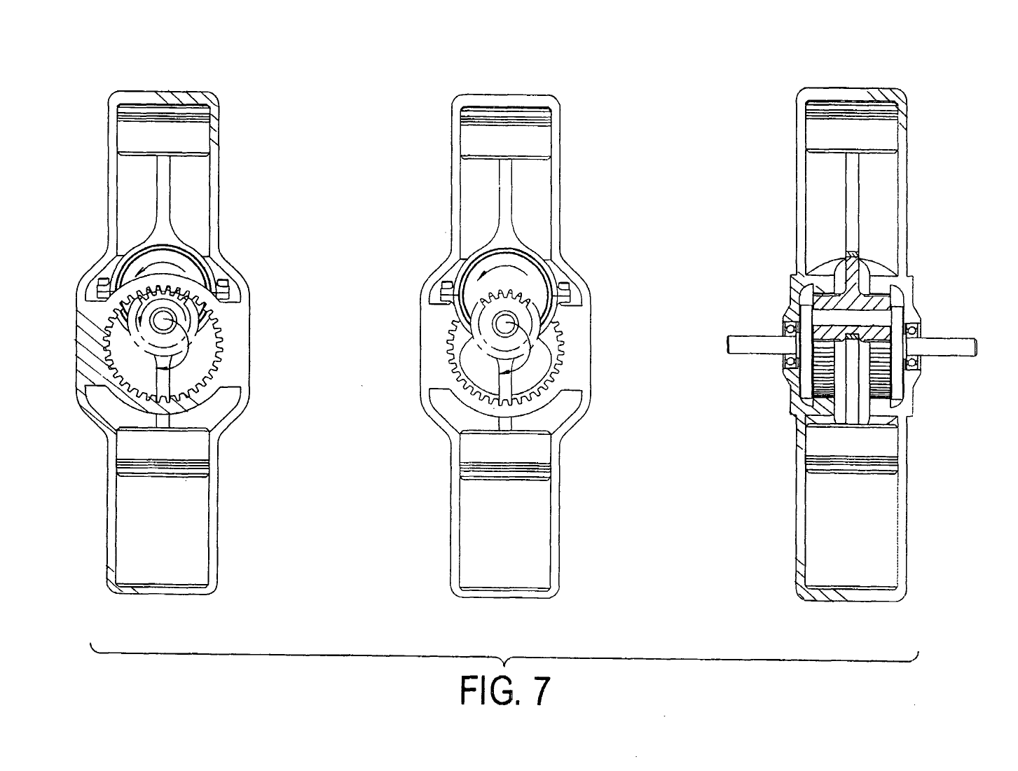

FIG. 6 shows a side cut-away of the assembled components rotating through one complete engine cycle in 90 degree increments including arrows depicting their rotational relationships. The counterclockwise arrow 61 indicates the rotation of the outermost portion of the disk-like portion of the pinion, i.e., the cylinder rod journal 12. Although not shown in FIG. 6, the movement of the longitudinal axis of the cylinder rod journal 12 (i.e., the center of the disk-like portion of the pinion) is purely linear. Specifically, when viewed from the perspective of FIG. 6, the longitudinal axis of the cylinder rod journal 12 moves in a straight line. The counterclockwise arrow 62 indicates the rotation of the pinion body 11 as it travels through a full cycle in engagement with the ring gear 30. The clockwise arrow 63 indicates the path of rotation of the offset longitudinal axis of the drive shaft (i.e., the longitudinal axis 22 of the drive shaft journal 23).

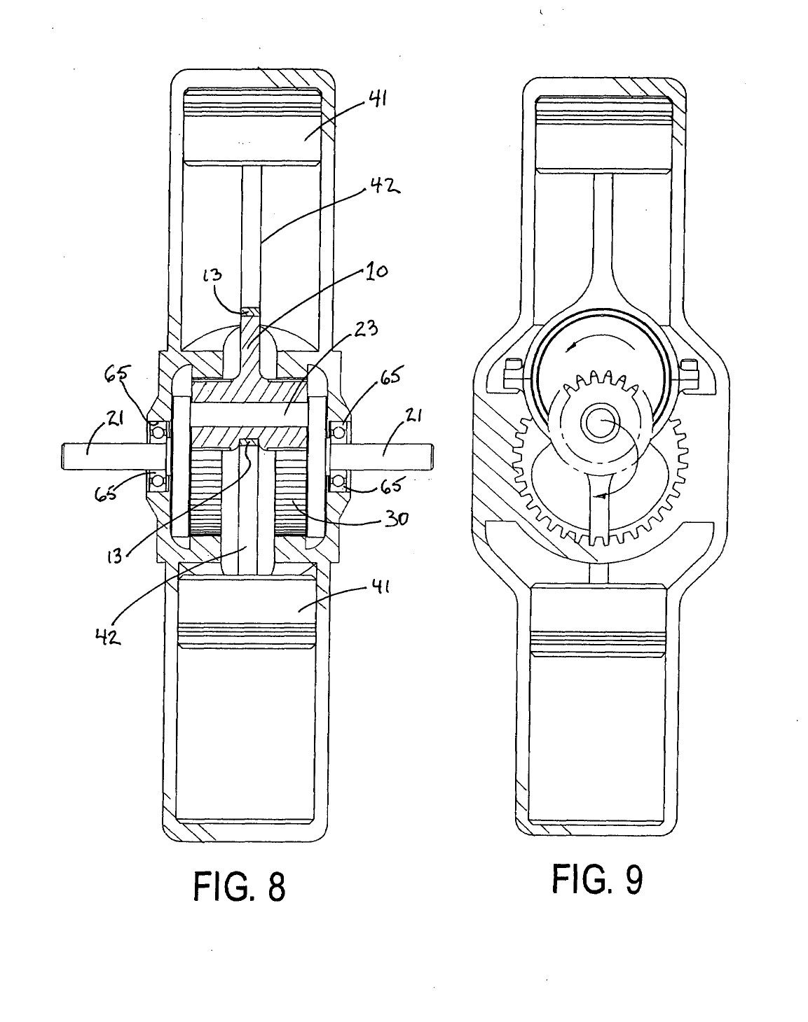

FIG. 8 shows a side sectional view of the assembled pinion gear assembly of the present invention connected to two opposed pistons 41 in an engine housing 35. The two bearings 65 between the two power output shafts 21 of the driveshaft and the engine housing are shown, the bearing between the piston rod assembly and the cylinder rod journal is shown, although for simplicity the bearing between the drive shaft journal 23 and the pinion 10 is not shown.

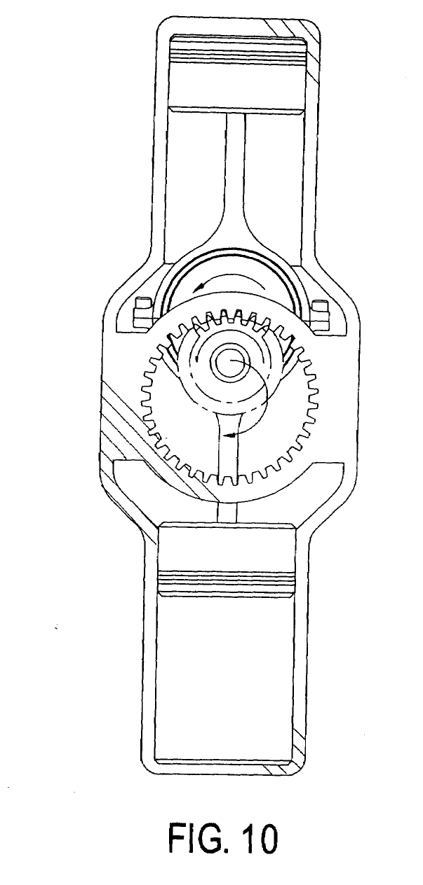

FIGS. 9 and 10 show side sectional views of the assembled pinion gear assembly of the present invention connected to two opposed pistons in an engine housing including arrows depicting their rotational relationships, and as above, counterclockwise rotation indicates pinion movement and clockwise rotation indicates drive shaft movement.

The gear ratio of the ring gear 30 to the pinion body 11 is 2 to 1. The ring gear 30 is held stationary within the engine housing 35 and does not move or rotate.

The longitudinal axis of said pinion body 80 is offset from the longitudinal axis of said cylinder rod journal 81 by an amount X shown in FIG. 1. The longitudinal axis of the drive shaft journal 82 is offset from the longitudinal axis of the power output shaft 83 by an amount Y shown in FIG. 2. X and Y are equal to each other and are each equal to one quarter of a stroke the engine piston 41. X and Y are also each equal to one quarter of the pitch diameter of the ring gear 30.

In the assembly process the pinion 10 is placed onto the driveshaft journal 23 and then one or both counterweight 25/power output shaft 21 assemblies are pressed onto the driveshaft journal 23 to make the driveshaft a unitary, one-piece unit with the pinion 11 able to rotate on its bearing around the axis of the drive shaft journal The hypocycloid engine assembly in accordance with the invention must be properly assembled for timing and/or synchronization. When the piston is at TDC, the centerlines of the cylinder rod journal, the pinion body and the driveshaft journal are all aligned with the centerline of the cylinder bore 37 (i.e., the opening of the engine housing 35 in which the piston 41 travels). The foregoing relationship between the moving components must be observed during assembly for the device to be properly timed. In addition, the ring gear must be positioned in the engine housing in such a way as to facilitate the aforementioned alignment and timing. If not, the longitudinal motion of the center of the cylinder rod journal (i.e., the center of the disk-like portion of the pinion), although still linear, would follow a path that is canted (on an angle) from the centerline of the cylinder bore.

It is contemplated that the pinion assembly of the present invention be used with any other type of engine, including but not limited to, a two-stroke engine, a four-stroke engine and a manually powered engine. Furthermore, the pinion assembly can be used in a variety of applications where linear energy needs to be converted to rotation energy or vice versa, such as hydraulic systems, compressors, pumps, electric drive systems and belt drive systems to name a few.

Although certain presently preferred embodiments of the present invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extend required by the appended claims and the applicable rules of law.

What is claimed is:

1. A hypocycloid engine pinion comprising:
a pinion body having a longitudinal axis and defining an opening adapted to receive a drive shaft journal;
a cylinder rod journal substantially adjacent to said pinion body and having a longitudinal axis substantially parallel to and laterally offset from said longitudinal axis of said pinion body,
whereby said cylinder rod journal is adapted to receive the drive shaft journal.

2. The hypocycloid engine pinion of claim 1 wherein said pinion body has teeth on its exterior surface.

3. A hypocycloid engine pinion assembly comprising the hypocycloid engine pinion of claim 2 and a ring gear having teeth on its interior surface wherein the exterior surface of the pinion body and the interior surface of the ring gear are in contact causing the teeth of the pinion body to mesh with the teeth of the ring gear.

4. The hypocycloid engine pinion assembly of claim 3 wherein the gear ratio of the ring gear to the pinion body is 2 to 1.

5. The hypocycloid engine pinion assembly of claim 3 further comprising the cylinder rod journal being connected to at least one cylinder rod of at least one engine piston; said cylinder rod being connected to at least one engine piston.

6. The hypocycloid engine pinion assembly of claim 5 wherein the longitudinal axis of said pinion body is offset from the longitudinal axis of said cylinder rod journal by an amount X.

7. The hypocycloid engine pinion assembly of claim 6 further comprising a drive shaft comprising:
at least one drive shaft journal having a longitudinal axis;
at least one power output shaft substantially adjacent to said drive shaft journal and having a longitudinal axis substantially parallel to and laterally offset from said longitudinal axis of said drive shaft journal;
wherein in operation said cylinder rod journal travels in a purely linear motion and said power output shaft in a purely rotational motion.

8. The hypocycloid engine pinion assembly of claim 7 wherein the longitudinal axis of said at least one drive shaft journal is offset from the longitudinal axis of said at least one power output shaft by an amount Y.

9. The hypocycloid engine pinion assembly of claim 8 wherein X and Y are each equal to one quarter of a stroke of said at least one engine piston.

10. The hypocycloid engine pinion assembly of claim 7 wherein said drive shaft is of a unitary, one-piece construction.

11. The hypocycloid engine pinion assembly of claim 7 wherein said at least one drive shaft journal is offset from said at least one power output shaft; and a counterweight connects the drive shaft journal and the power output shaft.

12. A drive shaft journal extending through an opening of a hypocycloid engine pinion body and through a cylinder rod journal, said pinion body having a longitudinal axis parallel and laterally offset from a longitudinal axis of said cylinder rod journal.

13. The hypocycloid engine assembly of claim 12 wherein said pinion body has teeth on its exterior surface.

14. The hypocycloid engine assembly of claim 13 further comprising a ring gear having teeth on its interior surface wherein the exterior surface of the pinion body and the interior surface of the ring gear are in contact causing the teeth of the pinion body to mesh with the teeth of the ring gear.

15. The hypocycloid engine assembly of claim 14 wherein the gear ratio of the ring gear to the pinion body is 2 to 1.

16. The hypocycloid engine assembly of claim 12 further comprising the cylinder rod journal being connected to at least one cylinder rod of at least one engine piston; said cylinder rod being connected to at least one engine piston.

17. The hypocycloid engine assembly of claim 16 wherein the longitudinal axis of said pinion body is offset from the longitudinal axis of said cylinder rod journal by an amount X.

18. The hypocycloid engine assembly of claim 17 wherein said drive shaft journal is an element of a drive shaft comprising:
said drive shaft journal having a longitudinal axis;
at least one power output shaft substantially adjacent to said drive shaft journal and having a longitudinal axis substantially parallel to and laterally offset from said longitudinal axis of said drive shaft journal;
wherein in operation said cylinder rod journal travels in a purely linear motion and said power output shaft in a purely rotational motion.

19. The hypocycloid engine assembly of claim 18 wherein the longitudinal axis of said at least one drive shaft journal is offset from the longitudinal axis of said at least one power output shaft by an amount Y.

20. The hypocycloid engine assembly of claim 19 wherein X and Y are each equal to one quarter of a stroke of said at least one engine piston.

21. The hypocycloid engine assembly of claim 18 wherein said drive shaft is of a unitary, one-piece construction.

22. The hypocycloid engine assembly of claim 18 wherein said at least one drive shaft journal is offset from said at least one power output shaft; and a counterweight connects the drive shaft journal and the power output shaft.

23. The hypocycloid engine pinion of claim 1 wherein said cylinder rod journal is adapted to receive the drive shaft journal by having an opening therein.

24. The hypocycloid engine assembly of claim 12 wherein said cylinder rod journal is adapted to receive the drive shaft journal by having an opening therein.

25. The hypocycloid engine pinion of claim 1 wherein said pinion is of a unitary, one-piece construction.

26. The hypocycloid engine assembly of claim 12 wherein said pinion body and said cylinder rod journal are a unitary, one-piece construction.
